(19) United States
(12) Patent Application Publication
(10) Pub. No.: US 2005/0094833 A1
(43) Pub. Date: May 5, 2005

(54) Encapsulated composite electrostatic loudspeaker stator

(76) Inventors: Charles P. Bloodworth, Macon, GA (US); Roger R. Sanders, Conifer, CO (US)

Correspondence Address: Roger R. Sanders, 12054 Deer Trail, Conifer, CO, 80433, US

(21) Appl. No.: 10/697,392

(22) Filed: Oct. 30, 2003

(51) Int. Cl. H04R 25/00

(52) U.S. Cl. 381/191; 381/170

(57) ABSTRACT

A method is described whereby composite materials and computer-controlled machining are used to completely encapsulate the conductors in the stators of an electrostatic loudspeaker. This process solves many difficult problems inherent in the construction of such speakers. These include the need for outstanding electrical insulation, avoidance of damage due to arcing, elimination of protective circuitry, durability, a high degree of flatness, high efficiency, light weight, ease of construction, and pleasing appearance.

An invention is described whereby composite materials are used to completely encapsulate and insulate conductors for use as the stators of an electrostatic loudspeaker. This process solves many difficult problems inherent in the construction of such speakers. These include the need for outstanding electrical insulation, reduced stray capacitance, minimal leakage, avoidance of damage due to arcing, elimination of protective circuitry, strength and durability, a high degree of flatness, high efficiency, light weight, ease of construction, and pleasing appearance.

### DESCRIPTION: FIELD OF THE INVENTION

The invention pertains generally to electrostatic sound reproducers, and more specifically to an improved type of stator (also known as electrode), which results in outstanding electronic and acoustic performance. Additionally the superior production precision makes construction of a complete electrostatic loudspeaker (ESL) relatively fast and easy with excellent cosmetic results.

### BACKGROUND TO THE INVENTION

An ESL typically consists of a flexible sound-producing diaphragm that is positioned between, and very close to, a pair of stators. A DC polarization voltage is applied to the diaphragm and the audio signal is superimposed upon the stators causing the diaphragm to move. It is also possible to superimpose the audio signal on the diaphragm, rather than the stators, and single-ended ESL's have been constructed using only a single stator.

The stator(s) must be acoustically transparent so that the sound produced by the diaphragm can radiate outwardly through the stators to the listening area. The stators must be electrically conductive so that the audio signal can be applied to them. They must be insulated to prevent arcing (sparking), which can damage or destroy the speaker, and to prevent electrical shocks when the stators surface is touched. The stators must be very flat to maintain high efficiency by remaining very close to the diaphragm without actually touching it, which would cause massive amounts of distortion.

ESL's operate at several thousand volts, and these voltages are applied across a small gap between the diaphragm and stator (1-3 mm, typically). As a result, it is very easy for an arc to form between the stator and the diaphragm, which can burn a hole in the diaphragm and cause speaker failure.

Inadequate insulation can allow electrical coronas to form that will gradually erode the diaphragm causing speaker failure. Inadequate insulation can allow slow electrical discharges (particularly in high humidity conditions) that cause sizzling or frying sounds to be heard from the speaker. To avoid these problems, be able to generate high output, and protect users from electrical shock, an ESL requires excellent electrical insulation.

Usually some type of conductive screen or grid is used for the stator. Historically, most ESL's have used metal stators that are coated with insulation or use insulated wire The individual conductive elements are dose enough together to collectively define an electrostatic plane, and the spaces between the elements of the stator provide apertures for the passage of sound produced by the diaphragm.

A wire stator uses a plurality of spaced parallel wire segments supported by a frame. Making a stator out of wire is very labor-intensive and expensive. The needed insulation is thick, so the wires must be placed too far apart to produce a strong electrical field. This results in poor efficiency. It is difficult to make the wires straight and temperature changes can cause them to go slack and fail to maintain the close tolerances required. Wire stators lack strength so require strong frames to support them. This causes them to be heavy, complex, and cosmetically unacceptable.

Perforated metal stators are much easier and less costly to build. These usually take the form of a sheet of steel or aluminum that is perforated with a multitude of tiny holes. The sheet is then coated with electrical insulation such as paint or plastic.

Getting a uniform coating of insulation on a sheet of perforated metal is virtually impossible due to the difficulty of getting coatings to cover sharp edges, and perforated metal has an abundance of sharp edges and burrs around the edges of the holes due to the perforating process. Also, insulating coatings contain contaminates that produce voids or conductive areas within the insulation coating itself.

The coating must be perfectly uniform because if it has even one void, pinhole, contaminate, thin area, or other defect, the speaker will arc at that point (the “weakest link in the chain” effect). It is impractical to make perforated metal stators with sufficient coating precision and uniformity to produce reliable high-output ESL's.

Due to the virtually insurmountable problems of coating perforated metal stators, some manufacturers have resorted to using plastic stators. Because plastic is an excellent insulator, theoretically it should make an excellent stator.

Because plastic is an insulator, it cannot conduct the audio voltage that the stator requires. So a conductive coating must be applied to the plastic. Typically, this conductive coating is applied to the outside of the stator, leaving the plastic to act as an insulating barrier between the diaphragm and the conductive part of the stator. Unfortunately, the voltages involved are so high that this is inadequate. An arc will simply go around the plastic insulation by going through the holes or slots in the stator, where it can reach the conductive traces on the outside. So a plastic stator must still have insulation applied over its conductive coating, and like a metal stator, this coating is rarely perfect.

The plastic stator also has the problem of being rather weak, so it must be made thick for adequate strength. This thickness moves the conducting area too far away from the diaphragm for high efficiency. As a result, plastic stators are inefficient and still subject to arcing.

An important variation of the plastic stator is the printed circuit board stator. Circuit boards are made of plastic such as epoxy, with glass fibers imbedded in the plastic. This type of construction has two advantages over a pure plastic stator. First, because the circuit board has fibers in it, it is quite strong, so can be made thin to keep the conductors close to the diaphragm for high efficiency.

The other advantage is that standard circuit board construction techniques can be used, which makes it very easy to apply tiny copper traces very precisely to the circuit board to produce a high-efficiency, conductive surface. Circuit board material is light, and very flat. This makes it ideal for making planar ESL's that require the maintenance of close tolerances over large areas.

Printed circuit board stators have been used to make ESL's for many years. However, they suffer from the same insulation problems as described above for perforated metal and plastic stators. In short, their conductors must still be coated with insulation, and the application of insulation is flawed, resulting in a stator that is still prone to arcing.

### SUMMARY OF THE INVENTION

Because circuit board material is inherently an extremely good insulator, a perfectly insulated stator could be constructed if a way were devised to encapsulate copper traces inside the printed circuit board, where the insulation is perfect. This would provide all the other benefits of a circuit board stator but with flawless, high-value insulation.

This invention does exactly that by laminating or imbedding conductors between two insulated panels during their manufacture. This invention includes but is not limited to stators constructed by laminating copper traces between two circuit boards during their manufacture. This produces the faultless insulation needed without the use of coatings.

Note that materials other than circuit board composites, fiberglass, and copper, can be used to construct stators to achieve a wide array of electrical and physical characteristics. This invention allows total encapsulation of the stators conductive elements in an insulating material, and is applicable to an array of insulators and conductors.

While this lamination process encapsulates the traces perfectly, there remains a very large problem: How does one obtain the needed perforations in the circuit board without damaging or exposing the copper traces inside? The problem is aggravated by the fact that the traces need to be close together for high efficiency.

The slots in the stator must be precisely located, and must not expose any of the conductor, as this would negate the benefits of encapsulation. While there are many ways to cut slots accurately, one excellent solution to this problem is the use of computer-controlled routing machines. These are now so accurate that they can reliably produce circuit boards with insulation thickness of only a few microns between the edges of the perforations and the encapsulated copper traces. This high level of precision further increases the efficiency of the electrostatic loudspeaker.

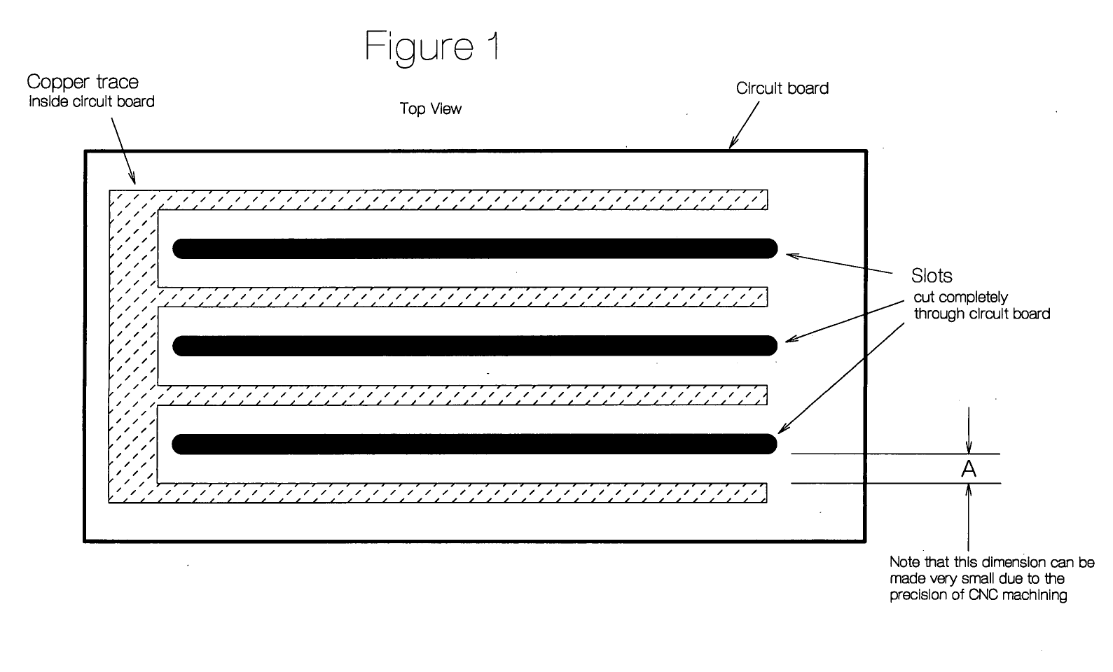

FIG. 1 shows a representative sample of such a printed circuit board. This shows slots cut completely through the circuit board with the copper traces encapsulated inside the board separated from the edge of the slots so that the copper traces remain completely encapsulated with no exposed copper surfaces anywhere. For clarity, this drawing shows rather large spacing between the slots and the traces (dimension “A”). In practice, the distances would be much smaller with many, closely spaced traces/slots. This is key to producing a high-efficiency speaker and the use of precision methods is essential to this process.

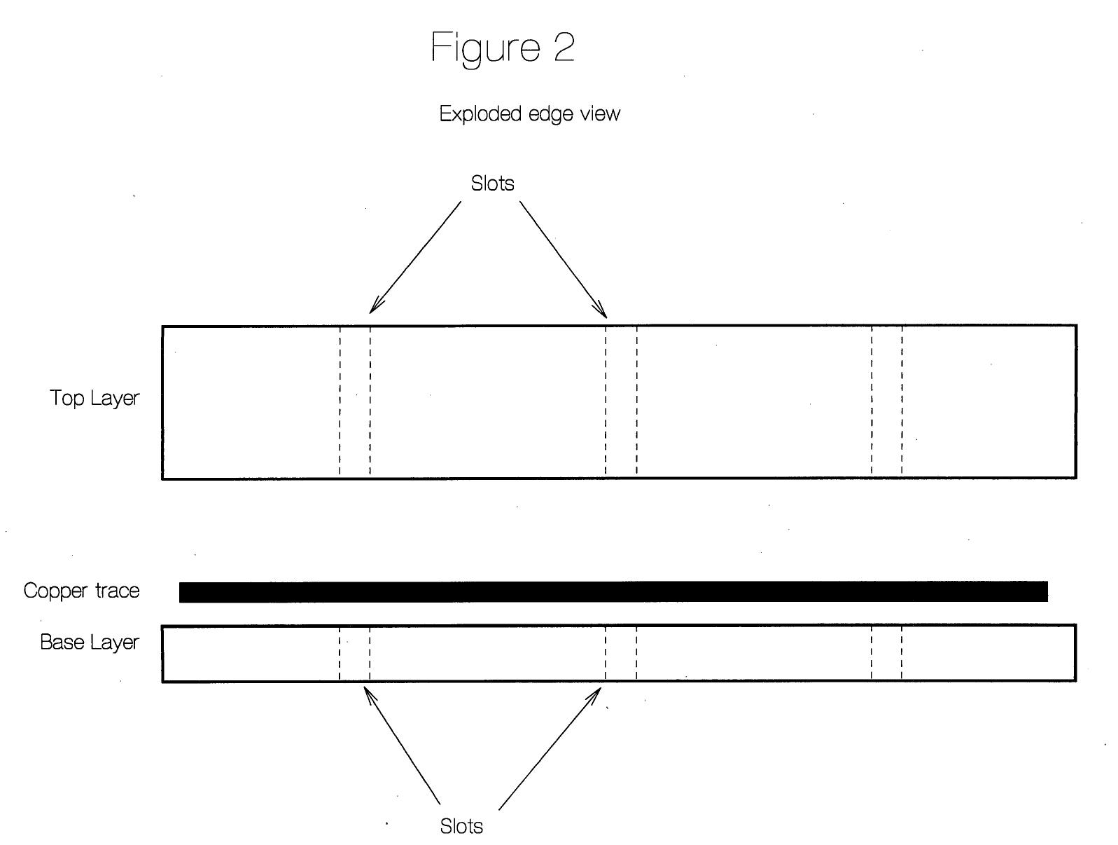

FIG. 2 shows an exploded edge view of the circuit board so that the various layers can be identified. Note that the two circuit board layers (“top” and “base” layers) that make up the final stator are not the same thickness. The thinner circuit board is placed on the inside of the speaker to keep the conductive trace close to the diaphragm for high efficiency. The other layer is thicker and used to produce adequate strength without sacrificing efficiency.

Note that this process would work with many different types of materials and perforations, so the invention is not limited to glass/epoxy circuit boards and slots. The material could be any insulator and any shape of perforation could be used.

### CLAIMS

We claim a fully encapsulated electrostatic loudspeaker stator, comprising:
a first element consisting of an insulating sheet,
a second element consisting of conductive material on the surface of or embedded in the first element,
a third element consisting of a second insulating sheet.

We claim the use of multi-layered PCB construction methods for constructing said stators.

We claim the use of CNC methods for constructing said stators.

We claim the use of offset encapsulation, where the insulating material is thicker on one side for strength, while being thinner on the other side to place the conductors closer to the diaphragm.

### BACKGROUND

The invention pertains generally to electrostatic sound reproducers, and more specifically to an improved type of stator (also known as electrode), which results in outstanding electronic and acoustic performance. Additionally the superior production precision makes construction of a complete electrostatic loudspeaker (ESL) relatively fast and easy with excellent cosmetic results.

An ESL fundamentally consists of a flexible sound-producing diaphragm that is positioned between, and very close to a pair of stators. A DC polarization voltage is applied to the diaphragm and the audio signal is superimposed upon the stators causing the diaphragm to move.

The stators must be acoustically transparent so that the sound produced by the diaphragm can radiate outwardly through the stators to the listening area. The stators must be electrically conductive so that the audio signal can be applied to them. They must be insulated to prevent arcing (sparking), which can damage or destroy the speaker. The stators must be very flat to maintain high efficiency by remaining very close to the diaphragm without actually touching it, which would cause massive amounts of distortion.

Usually some type of conductive screen or grid is used for the stator. The individual conductive elements are close enough together to collectively define an electrostatic plane, and the spaces between the elements of the stator provide apertures for the passage of sound produced by the diaphragm.

ESLs operate at several thousand volts, and these voltages are applied across a small gap between the diaphragm and stator (1-3 mm, typically). As a result, it is very easy for an arc to form between the stator and the diaphragm, which can burn a hole in the diaphragm and cause speaker failure.

Inadequate insulation can allow electrical coronas to form that will gradually erode the diaphragm causing speaker failure. Inadequate insulation can allow slow electrical discharges (particularly in high humidity conditions) that cause sizzling or frying sounds to be heard from the speaker. To avoid these problems, be able to generate high output, and protect users from electrical shock, an ESL requires excellent electrical insulation.

Historically, most ESLs use metal stators that are coated with insulation. These often take the form of insulated wire or a flat sheet of perforated metal that has been coated with insulation.

A wire stator uses a plurality of spaced parallel wire segments supported by a frame. Making a stator out of wire is very labor-intensive and expensive to build. The needed insulation is thick, so the wires must be placed too far apart to produce a strong electrical field. This results in poor efficiency. It is difficult to make the wires straight and temperature changes can cause them to go slack and fail to maintain the close tolerances required. Wire stators lack strength so require strong frames to support them. This causes them to be heavy, complex, and cosmetically unacceptable.

Perforated metal stators are much easier and less costly to build. These usually take the form of a sheet of steel or aluminum that is perforated with a multitude of tiny holes. The sheet is then coated with electrical insulation such as paint or plastic.

Getting a uniform coating of insulation on a sheet of perforated metal is virtually impossible due to the difficulty of getting coatings to cover sharp edges—and perforated metal has an abundance of sharp edges and burrs around the edges of the holes due to the perforating process. Also, insulating coatings contain contaminates that produce voids or conductive areas within the insulation coating itself.

The coating must be perfectly uniform because if it has even one void, pin-hole, contaminate, thin area, or other defect, the speaker will arc at that point (the “weakest link in the chain” effect). It is impractical to make perforated metal stators with sufficient coating precision and uniformity to produce high-output ESLs.

Due to the virtually insurmountable problems of coating perforated metal stators, some manufacturers have resorted to using plastic stators. Because plastic is an excellent insulator, theoretically it should make an excellent stator.

Because plastic is an insulator, it cannot conduct the audio voltage that the stator requires. So a conductive coating must be applied to the plastic. Typically, this conductive coating is applied to the outside of the stator, leaving the plastic to act as an insulating barrier between the diaphragm and the conductive part of the stator.

Unfortunately, the voltages involved are so high that this is inadequate. An arc will simply go around the plastic insulation by going through the slots to where it can reach the conductive traces on the outside. So a plastic stator must still have insulation applied over its conductive coating—and like a metal stator, this coating is rarely perfect.

The plastic stator also has the problem of being rather weak, so it must be made quite thick for adequate strength. This thickness moves the conducting area too far away from the diaphragm for high efficiency. As a result, plastic stators are inefficient and still prone to arcing.

An important variation of the plastic stator is the printed circuit board stator. Circuit boards are made of plastic such as epoxy, with glass fibers imbedded in the plastic.

This type of construction has two advantages over a pure plastic stator. First, because the circuit board has fibers in it, it is quite strong, so can be made thin to keep the conductors close to the diaphragm for high efficiency. The other advantage is that standard circuit board construction techniques can be used, which makes it very easy to apply tiny copper traces very precisely to the circuit board to produce a high-efficiency, conductive surface.

Circuit board material is light, and very flat. This makes it ideal for making planar ESLs that require the maintenance of close tolerances over large areas.

Printed circuit board stators have been used to make ESLs for many years. However, they suffer from the same insulation problems as described above for perforated metal and plastic stators. In short, their conductors must still be coated with insulation, and the application of insulation is flawed, resulting in a stator that is still prone to arcing.

### DESCRIPTION OF THE INVENTION

Because circuit board material is inherently an extremely good insulator, a perfectly insulated stator could be made if a way were devised to encapsulate copper traces inside the printed circuit board, where the insulation is perfect. This would provide all the other benefits of a circuit board stator but with flawless, high-value insulation.

This invention does exactly that by laminating the copper traces between two circuit boards during their manufacture. This produces the faultless insulation needed without the use of coatings.

While this lamination process encapsulates the traces perfectly, there remains a very large problem: How does one obtain the needed perforations in the circuit board without damaging or exposing the copper traces inside? The problem is aggravated by the fact that the traces need to be close together for high efficiency.

The solution to this problem is the use of computer-controlled routing machines. These are now so accurate that they can reliably produce circuit boards with insulation thicknesses of only a few microns between the edges of the perforations and the encapsulated copper traces.

FIG. 1 shows a representative sample of such a printed circuit board. This shows slots cut completely through the circuit board with the copper traces encapsulated inside the board separated from the edge of the slots so that the copper traces remain completely encapsulated with no exposed copper surfaces anywhere.

For clarity, this drawing shows rather large spacing between the slots and the traces (dimension “A”). In practice, the distances would be much smaller with many, closely-spaced traces/slots. This is key to producing a high-efficiency speaker and the use of precision machinery is essential to this process.

FIG. 2 shows an exploded edge view of the circuit board so that the various layers can be identified. Note that the two circuit board layers (“top” and “base” layers) that make up the final stator are not the same thickness. The thinner circuit board is placed on the inside of the speaker to keep the conductive trace close to the diaphragm for high efficiency. The other layer is thicker and used to produce adequate strength without sacrificing efficiency.

Note that this process would work with many different types of materials and perforations, so the invention is not limited to glass/epoxy circuit boards and slots. The material could be any insulator and any shape of perforation could be used.

Background

The invention pertains generally to electrostatic sound reproducers, and more specifically to an improved type of stator (also known as electrode), which results in outstanding electronic and acoustic performance. Additionally the superior production precision makes construction of a complete electrostatic loudspeaker (ESL) relatively fast and easy with excellent cosmetic results.

An ESL fundamentally consists of a flexible sound-producing diaphragm that is positioned between, and very close to a pair of stators. A DC polarization voltage is applied to the diaphragm and the audio signal is superimposed upon the stators causing the diaphragm to move.

The stators must be acoustically transparent so that the sound produced by the diaphragm can radiate outwardly through the stators to the listening area. The stators must be electrically conductive so that the audio signal can be applied to them. They must be insulated to prevent arcing (sparking), which can damage or destroy the speaker. The stators must be very flat to maintain high efficiency by remaining very close to the diaphragm without actually touching it, which would cause massive amounts of distortion.

Usually some type of conductive screen or grid is used for the stator. The individual conductive elements are close enough together to collectively define an electrostatic plane, and the spaces between the elements of the stator provide apertures for the passage of sound produced by the diaphragm.

ESLs operate at several thousand volts, and these voltages are applied across a small gap between the diaphragm and stator (1-3 mm, typically). As a result, it is very easy for an arc to form between the stator and the diaphragm, which can burn a hole in the diaphragm and cause speaker failure.

Inadequate insulation can allow electrical coronas to form that will gradually erode the diaphragm causing speaker failure. Inadequate insulation can allow slow electrical discharges (particularly in high humidity conditions) that cause sizzling or frying sounds to be heard from the speaker. To avoid these problems, be able to generate high output, and protect users from electrical shock, an ESL requires excellent electrical insulation.

Historically, most ESLs use metal stators that are coated with insulation. These often take the form of insulated wire or a flat sheet of perforated metal that has been coated with insulation.

A wire stator uses a plurality of spaced parallel wire segments supported by a frame. Making a stator out of wire is very labor-intensive and expensive to build. The needed insulation is thick, so the wires must be placed too far apart to produce a strong electrical field. This results in poor efficiency. It is difficult to make the wires straight and temperature changes can cause them to go slack and fail to maintain the close tolerances required. Wire stators lack strength so require strong frames to support them. This causes them to be heavy, complex, and cosmetically unacceptable.

Perforated metal stators are much easier and less costly to build. These usually take the form of a sheet of steel or aluminum that is perforated with a multitude of tiny holes. The sheet is then coated with electrical insulation such as paint or plastic.

Getting a uniform coating of insulation on a sheet of perforated metal is virtually impossible due to the difficulty of getting coatings to cover sharp edges—and perforated metal has an abundance of sharp edges and burrs around the edges of the holes due to the perforating process. Also, insulating coatings contain contaminates that produce voids or conductive areas within the insulation coating itself.

The coating must be perfectly uniform because if it has even one void, pin-hole, contaminate, thin area, or other defect, the speaker will arc at that point (the “weakest link in the chain” effect). It is impractical to make perforated metal stators with sufficient coating precision and uniformity to produce high-output ESLs.

Due to the virtually insurmountable problems of coating perforated metal stators, some manufacturers have resorted to using plastic stators. Because plastic is an excellent insulator, theoretically it should make an excellent stator.

Because plastic is an insulator, it cannot conduct the audio voltage that the stator requires. So a conductive coating must be applied to the plastic. Typically, this conductive coating is applied to the outside of the stator, leaving the plastic to act as an insulating barrier between the diaphragm and the conductive part of the stator.

Unfortunately, the voltages involved are so high that this is inadequate. An arc will simply go around the plastic insulation by going through the slots to where it can reach the conductive traces on the outside. So a plastic stator must still have insulation applied over its conductive coating—and like a metal stator, this coating is rarely perfect.

The plastic stator also has the problem of being rather weak, so it must be made quite thick for adequate strength. This thickness moves the conducting area too far away from the diaphragm for high efficiency. As a result, plastic stators are inefficient and still prone to arcing.

An important variation of the plastic stator is the printed circuit board stator. Circuit boards are made of plastic such as epoxy, with glass fibers imbedded in the plastic.

This type of construction has two advantages over a pure plastic stator. First, because the circuit board has fibers in it, it is quite strong, so can be made thin to keep the conductors close to the diaphragm for high efficiency. The other advantage is that standard circuit board construction techniques can be used, which makes it very easy to apply tiny copper traces very precisely to the circuit board to produce a high-efficiency, conductive surface.

Circuit board material is light, and very flat. This makes it ideal for making planar ESLs that require the maintenance of close tolerances over large areas.

Printed circuit board stators have been used to make ESLs for many years. However, they suffer from the same insulation problems as described above for perforated metal and plastic stators. In short, their conductors must still be coated with insulation, and the application of insulation is flawed, resulting in a stator that is still prone to arcing.

Description of the Invention

Because circuit board material is inherently an extremely good insulator, a perfectly insulated stator could be made if a way were devised to encapsulate copper traces inside the printed circuit board, where the insulation is perfect. This would provide all the other benefits of a circuit board stator but with flawless, high-value insulation.

This invention does exactly that by laminating the copper traces between two circuit boards during their manufacture. This produces the faultless insulation needed without the use of coatings.

While this lamination process encapsulates the traces perfectly, there remains a very large problem: How does one obtain the needed perforations in the circuit board without damaging or exposing the copper traces inside? The problem is aggravated by the fact that the traces need to be close together for high efficiency.

The solution to this problem is the use of computer-controlled routing machines. These are now so accurate that they can reliably produce circuit boards with insulation thicknesses of only a few microns between the edges of the perforations and the encapsulated copper traces.

FIG. 1 shows a representative sample of such a printed circuit board. This shows slots cut completely through the circuit board with the copper traces encapsulated inside the board separated from the edge of the slots so that the copper traces remain completely encapsulated with no exposed copper surfaces anywhere.

For clarity, this drawing shows rather large spacing between the slots and the traces (dimension “A”). In practice, the distances would be much smaller with many, closely-spaced traces/slots. This is key to producing a high-efficiency speaker and the use of precision machinery is essential to this process.

FIG. 2 shows an exploded edge view of the circuit board so that the various layers can be identified. Note that the two circuit board layers (“top” and “base” layers) that make up the final stator are not the same thickness. The thinner circuit board is placed on the inside of the speaker to keep the conductive trace close to the diaphragm for high efficiency. The other layer is thicker and used to produce adequate strength without sacrificing efficiency.

Note that this process would work with many different types of materials and perforations, so the invention is not limited to glass/epoxy circuit boards and slots. The material could be any insulator and any shape of perforation could be used.

1) A stator for electrostatic speakers that is light weight

2) A stator that is strong

3) A stator whose conductors are fully encapsulated within a printed circuit board, so is capable of accepting and confining high voltages to within the stator itself

4) A stator that can be made with such precision as to generate very high efficiency in the finished speaker

5) A stator whose efficiency and insulating qualities are so good that an electrostatic speaker can play very loudly

6) A stator that has a pleasing appearance

7) A stator that does not need electrical protection circuitry to prevent arcing and speaker damage

8) A stator with such excellent insulation that it virtually eliminates the risk of personal injury due to electrical shock

9) A stator that is inherently very flat, but that is also flexible enough to be bent into a curved shape for building wide-dispersion ESLs if desired

10) A stator that is relatively easy to assemble into a large, complete, electrostatic panel

11) A stator that produces no extraneous sounds
